(19) United States
(12) Patent Application Publication
(10) Pub. No.: US 2013/0126745 A1
(43) Pub. Date: May 23, 2013

(54) SEMICONDUCTOR X-RAY DETECTOR

(71) Applicants: Yoshiaki Watanabe, Hino (JP); Yoshinori Ueji, Akishima (JP)

(72) Inventors: Yoshiaki Watanabe, Hino (JP); Yoshinori Ueji, Akishima (JP)

(21) Appl. No.: 13/812,559

(22) PCT Filed: Jul. 29, 2011
(86) PCT No.: PCT/JP2011/067515

§ 371 Date: Jan. 28, 2013

(30) Foreign Application Priority Data
Jul. 30, 2010 (JP) 2010-172597

(51) Int. Cl. G01T 1/24

(52) U.S. Cl. CPC G01T 1/24
USPC 250/370.09

(57) ABSTRACT

A semiconductor X-ray detector comprises: a semiconductor X-ray sensor portion 10, which has a plate-like outer shape including an opening portion 11 near to a central portion thereof, and is formed with plural numbers of pixel-like X-ray sensors between a surface and a reverse surface thereof; and a read-out portion 20, which is disposed on the reverse surface of the semiconductor X-ray sensor portion, and executes a predetermined process on each of signals outputted from the plural numbers of the X-ray sensors building up the semiconductor X-ray sensor portion, thereby outputting detected signals therefrom. The read-out portion is built up by assembling read-out units in plural numbers thereof, flatly in one body, each being formed into a rectangular shape, respectively, and forming plural numbers of pads on a surface thereof, as well as, having plural numbers of processing circuit portions and plural numbers of through hole vias in an inside thereof, and further having plural numbers of pads on a reverse surface thereof. The semiconductor X-ray sensor portion and the read-out portion are laminated to form into one body.

### TECHNICAL FIELD OF THE INVENTION

The present invention relates to a semiconductor X-ray detector for detecting an X-ray(s) to be used in various kinds of analyses, and in particular, it relates to the semiconductor X-ray detector having a novel structure, being suitable for detecting the X-ray(s) diffracted from a sample.

### BACKGROUND OF THE INVENTION

Analyses of various kinds of samples with using the X-ray (s) are adopted widely, in a field of so-called a non-destructive analysis, for example, because of not accompanying destructiveness of the sample. Conventionally, for example, in the following Patent Document 1 is already known a hand-held type X-ray diffractometer, mounting an X-ray generating apparatus and a 2-dimensional (or, area) X-ray detector and being portable.

On the other hand, for the purpose of detecting intensity of the X-ray or the like, although an imaging plate (IP), such as, a photo-sensitive film, etc., has been used, in general; however, accompanying with a remarkable development of a semiconductor manufacturing technology in recent years, various kinds of X-ray detectors are developed. For example, in the following Patent Document 2 is already disclosed a photon counting mode (PCM) detector equipped with plural numbers of pixels, in which a cadmium zinc telluride (CZT) detector and an ASIC chip mounting one (1) or more number (s) of read-out circuit (s) thereon are combined with. Also, in the following Patent Document 3 is already known a method for monitoring a dose of radioactivity corrected on the pixel and an X-ray detector for the same, in particular, in an apparatus equipped with plural numbers of such pixels. And, in the following Patent Document 4 is also already known an X-ray imaging device applying a semiconductor X-ray array detector therein.

Furthermore, in the following Patent Document 4 is also already known the structure for achieving compactification of detector (i.e., achieving a compact detector), and also for eliminating a dead space, which is generated when aligning the plural numbers the detectors each having a unit of pixels, therefrom.

### PRIOR ART DOCUMENTS

### Patent Documents

[Patent Document 1] U.S. Pat. No. 7,646,847;
[Patent Document 2] Japanese Patent Laying-Open for PCT No. 2007-524234 (2007);
[Patent Document 3] Japanese Patent Laying-Open for PCT No. 2007-529004 (2007);
[Patent Document 4] Japanese Patent Laying-Open No. Hei 8-102890 (1996); and
[Patent Document 5] Japanese Patent Laying-Open No. 2003-66151 (2003).

However, such conventional technology as was mentioned above has the following problems. Namely, when detecting the X-rays from the sample, in particular, the diffracted X-rays, the X-rays are diffracted on a concentric circle surrounding the sample, within a 3-dimensional space. For this reason, in order to detect such the diffracted X-ray, it is necessary that also the semiconductor X-ray detector has a detecting region expanding in a plane-like (i.e., 2-dimensional) manner, being similar to the conventional imaging plate, etc. However, for the detector according to the conventional technologies mentioned above, because of the structures and the manufacturing technologies thereof, it is difficult to maintain the detecting region having a size, being sufficiently large, and therefore, for example, within the X-ray diffractometer disclosed in the Patent Document 1 mentioned above are applied plural numbers of 1-dimensional (i.e., line) sensors or 2-dimensional (e.g., area) sensors, being combined with, in other words, by means of plural numbers of semiconductor X-ray detectors, which are diversely disposed, such diffracted X-rays are detected, separately, and in a process thereafter, they are analyzed by relating them with each other. For that reason, it is difficult to achieve an analysis of the diffracted X-rays at high accuracy.

Also, as is shown in the Patent Documents 2-4 mentioned above, with the semiconductor X-ray detector, in particular, because of a wiring portion in an array structure including the ASIC, and especially, the structures disposed on a surface of a substrate, it is difficult to obtain an X-ray detector having a desired shape, combining those X-ray detector elements by only a desired number thereof.

However, in the Patent Document 5 mentioned above, for the purpose of eliminating to generate the dead space, in particular, when aligning the plural numbers of the detectors, each having a unit of pixels, plural numbers of detector elements are arranged in two lines, so that the wiring portion, e.g., a draw-out pad of each element is disposed on an outside. However, with such arrangement/structure, if the detector elements are arranged covering over lines more than two (2), the dead space (s) is/are generated; it is also difficult to obtain the X-ray detector having the desired shape with combining the detectors by the desired number thereof.

Then, according to the present invention, being accomplished by taking the problem (s) in the conventional technologies mentioned above into the consideration thereof, an object thereof is to provide a semiconductor X-ray detector having a novel structure, i.e., a semiconductor X-ray detector element, which can be constructed with, into a desired shape by combining plural numbers of units, and in particular, which can be constructed into the shape being suitable for detection of the diffracted X-rays in a short distance with forming an opening portion at a central portion thereof.

### BRIEF SUMMARY OF THE INVENTION

First of all, according to the present invention, for accomplishing the object mentioned above, there is provided a semiconductor X-ray detector, comprising: a semiconductor X-ray sensor portion, which has a plate-like outer shape including at least an opening portion near to a central portion thereof, and is formed with plural numbers of pixel-like X-ray sensors between a surface and a reverse surface thereof; and a read-out portion, which is disposed on the reverse surface of said semiconductor X-ray sensor portion, and executes a predetermined process on each of signals outputted from the plural numbers of said X-ray sensors building up said semiconductor X-ray sensor portion, thereby outputting detected signals therefrom, wherein said read-out portion is built up by assembling read-out units in plural numbers thereof, flatly in one body, each being formed into a plate-like rectangular shape, with forming plural numbers of input portions on a surface thereof, as well as, having plural numbers of processing circuit portions and plural numbers of through hole vias in an inside thereof, and further having plural numbers of output terminals on a reverse surface thereof, and further said semiconductor X-ray sensor portion and said read-out portion are laminated to be formed into one body.

Also, according to the present invention, in the semiconductor X-ray detector, as described in the above, it is preferable that said semiconductor X-ray sensor portion has an opening portion at a central portion thereof, and an outer shape thereof is made O-shaped or U-shaped, or circular, or that a number of the plural numbers of pixel-like X-ray sensors for building up said semiconductor X-ray sensor portion is nearly equal to a total number of the processing circuit portions, which are formed in an inside of said read-out portion, being built up with plural numbers of said read-out units. And, it is also preferable that each of said plural numbers of read-out units for building up said read-out portion is constructed with ASIC, in an inside of which said plural numbers of processing circuit portions are formed in a 3-dimensional manner, or that the detected signals outputted from said read-out portion are intensity signals of incident X-rays.

Also, according to the present invention, for accomplishing the object mentioned above, too, there is further provided a semiconductor X-ray detector, comprising: a semiconductor X-ray sensor portion, which has a plate-like outer shape including at least an opening portion near to a central portion thereof, and is formed with plural numbers of pixel-like X-ray sensors between a surface and a reverse surface thereof; and a read-out portion, which is disposed on the reverse surface of said semiconductor X-ray sensor portion, and executes a predetermined process on each of signals outputted from the plural numbers of said X-ray sensors building up said semiconductor X-ray sensor portion, thereby outputting detected signals therefrom, wherein said read-out portion is built up with plural numbers read-out units, each being formed into a plate-like rectangular shape, with forming plural numbers of input portions on a surface thereof, as well as, having plural numbers of processing circuit portions and plural numbers of through hole vias in an inside thereof, and further having plural numbers of output terminals on a reverse surface thereof, said semiconductor X-ray sensor portion is laminated on each of surfaces of the read-out units for building up said read-out portion, to be formed in one body, and said read-out portion and said semiconductor X-ray sensor portion are assembled flatly in one body, by plural numbers of units, each including said read-out unit and a part of said semiconductor X-ray sensor portion, which is laminated on a surface thereof in one body.

### EFFECT(S) OF THE INVENTION

According to the present invention mentioned above, the following very superior effect can be achieved; i.e., it is possible to provided the semiconductor X-ray detector having the novel structure, easily, i.e., the semiconductor X-ray detector element, which can be constructed with, into a desired shape by combining plural numbers of units, and in particular, which can be constructed into the shape being suitable for detection of the diffracted X-rays in a short distance with forming an opening portion at a central portion thereof.

### BRIEF DESCRIPTION OF THE DRAWINGS

FIG. 1 is an exploded perspective view for showing the entire structure or configuration of a semiconductor X-ray detector, according to an embodiment of the present invention;

FIG. 2 is a view for showing the details of a read-out unit of the semiconductor X-ray detector mentioned above, in relation with an X-ray sensor (e.g., a cell);

FIG. 3 is a perspective view for showing the read-out unit of the semiconductor X-ray detector mentioned above, in particular, for a reserve side surface thereof;

FIG. 4 is a block diagram for showing the circuitry structure of an X-ray analyzing apparatus as a whole, in case when applying the semiconductor X-ray detector, according to the present invention, therein;

FIG. 5 is a perspective view for showing an example of detection of the diffracted X-rays by means of the semiconductor X-ray detectors, according to the present invention;

FIG. 6 is an exploded perspective view for showing the structure of the semiconductor X-ray detector, according to a variation of the present invention;

FIG. 7 is an exploded perspective view for showing the structure of the semiconductor X-ray detector, according to a further variation of the present invention;

FIG. 8 is an exploded perspective view for showing the structure of the semiconductor X-ray detector, according to a further other variation of the present invention;

FIG. 9 is an exploded perspective view for showing the structure of the semiconductor X-ray detector, according to a further other variation of the present invention; and

FIG. 10 is an exploded perspective view for showing the structure of the semiconductor X-ray detector, according to a further other variation of the present invention.

### DETAILED DESCRIPTION OF THE PREFERRED EMBODIMENTS

Hereinafter, explanation will be given, fully in details thereof, on a semiconductor X-ray detector, according to the embodiments of the present embodiment, by referring to the drawings attached herewith.

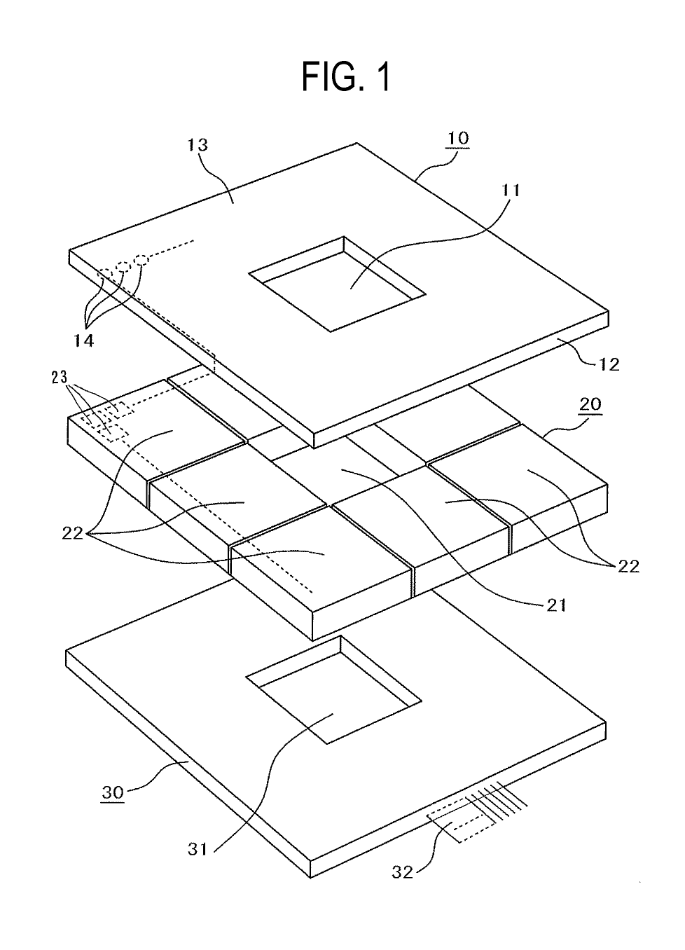

First of all, FIG. 1 shows the entire structures of an X-ray detector, according to the present invention. In this figure, a reference numeral 10 depicts so-called a semiconductor X-ray sensor portion, which is made of, for example, CdTe, CdZnTe, etc., wherein, as will be mentioned later, it is formed to be nearly quadrate, in an outer configuration thereof, from a semiconductor, and further, it has an X-ray detecting portion 12 providing an opening portion (e.g., a hole) 11 at a central portion thereof. And, on one surface (an upper surface in the figure) of that X-ray detecting portion 12 is formed a bias electrode 13 for applying a negative potential, with using a transparent material, such as, ITO (Indium Tin Oxide), etc., for example, while on the other surface thereof (a lower surface in the figure) are formed a large number of X-ray sensors, i.e., so-called, detecting electrodes 14, 14 . . . for detecting an electron generating due to energy of an X-ray, in a pixel-like shape. Thus, on this semiconductor X-ray sensor portion 10 are built up a large number of pixel-like X-ray sensors (or cells), with the bias electrode 13 and the detecting electrodes 14, which are arranged so as to put the X-ray detecting portion 12 made of the semiconductor between them, and they are disposed aligning in an array-like manner. However, as is shown in the figure, forming of this semiconductor sensor portion 10 into a hollow shape, though will be also mentioned later, enables to bring about a superior effect, in particular, when detecting the intensity of a ring-like diffracted X-ray, which is generated from a sample.

Next, on a lower surface of the semiconductor X-ray sensor portion 10 mentioned above is provided a read-out portion 20 having the same shape thereto (i.e., being formed to be nearly quadrate in the outer configuration thereof, and also being provided an opening portion (e.g., a hole) 21 at a central portion thereof). This read-out portion 20, as is apparent from the figure, is built up by combining plural numbers of portions thereof (e.g., read-out units 22, 22 . . . : however, eight (8) pieces in the present example), and in each thereof, various kinds of circuits are built up, in a 3-dimensional manner, with a through Si via (i.e., an electrode perpendicularly penetrating through an inside of the semiconductor chip made of silicon, etc., through so-called ASIC (Application Specific Integrated Circuit), respectively. Also, on a surface thereof are formed a large number of read-out portions 23, 23 . . . , corresponding to the positions of the detecting electrodes 14, 14 . . . of the semiconductor X-ray sensor portion 10 mentioned above. And, below this read-out portion 20 is further provided a wiring portion 30 having the same shape thereto (i.e., being formed to be nearly quadrate in the outer configuration thereof, and also being provided an opening portion (e.g., a hole) 31 at a central portion thereof), being made up with wire bonding pads, wherein outputs from the large number of X-ray sensors (e.g., the detecting electrodes 14, 14 . . . ) are outputted through a terminal portion 32, which is provided in apart of that wiring portion 30 (in the present example, on a sidewall portion thereof), and also various kinds of voltages necessary for, which will be mentioned later, are supplied to the semiconductor X-ray sensor portion 10 through the read-out portion 20 mentioned above.

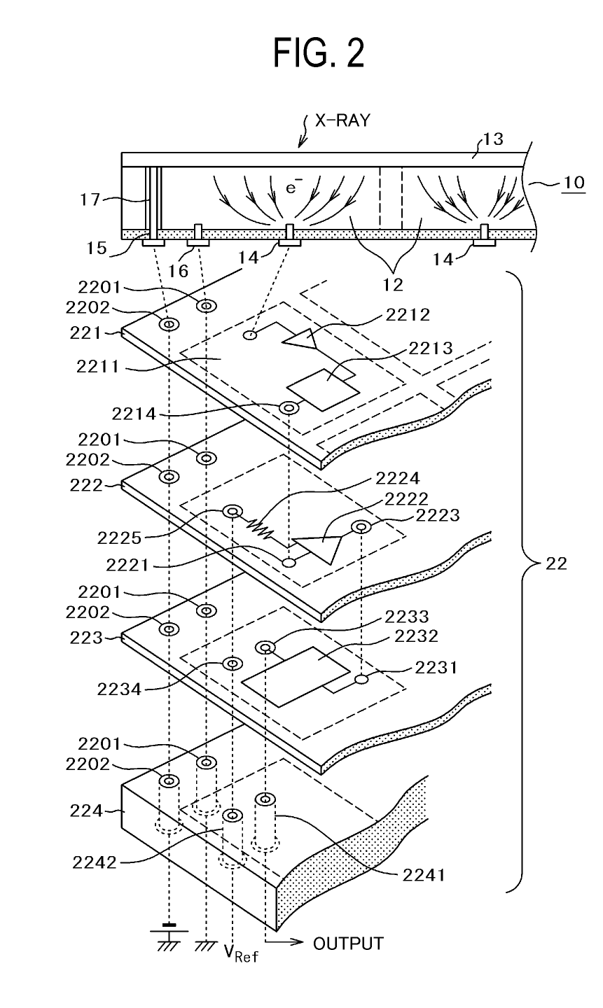

Next, FIG. 2 attached herewith shows the read-out portion 20 built up with the ASICs mentioned above, in particular, the details of the read-out units 22 building up the read-out portion, together with the details of the X-ray sensors (or cells) building up the semiconductor X-ray sensor portion 10 mentioned above.

Firstly, the X-ray sensor (or cell) is built up, as was mentioned above, the X-ray detecting portion 12, and the bias electrode 13 and the detecting electrodes 14, which are disposed while putting that between them. However, in this figure, a reference numeral 15 depicts an insulating layer formed on a lower surface of the X-ray detecting portion 12 mentioned above, and as is apparent from this figure, the detecting electrodes 14 are formed through this insulating layer 15, and a lower end portion thereof is shaped like a pad. Also, in part of the lower surface of the semiconductor X-ray sensor portion 10 are formed earth electrodes 16, in the similar manner to that of the detecting electrodes mentioned above, and also there are further formed bias terminals 17 for leading the bias electrodes 13 to bias voltage (e.g., negative voltage: −V_{B}), each being in the form of so-called the through Si via, filling up an inside thereof with a conductive material through the insulating layer, and a lower end portion thereof is shaped like a pad.

And in the present example, the read-out unit 22 made up with the ASIC is constructed with four (4) layers of the substitutes, for example, and also, as is apparent from the figure, on each of those four (4) layers of substitutes is formed a read-out circuit, which will be mentioned later, respectively, and they are piled up, to be formed in one body.

First of all, in the figure, on a surface of a first layer 221 at the upmost portion, as is shown by broken lines, a pad 2211 is formed as an input terminal for a detected signal, i.e., corresponding to the position of the detecting electrode 14 of the semiconductor X-ray sensor portion 10 mentioned above, and at the position corresponding to the X-ray detecting portion 12 mentioned above are provided an amplifier 2212 for amplifying a signal to be detected up to a desired amplitude and a wave shaping circuit 2213 for shaping up the waveform of that signal amplified. And, an output of that wave shaping circuit 2213 is further connected to other through Si via 2214. Also, a reference numeral 2201 in the figure depicts the through Si via, which is formed corresponding to the pad of the earth electrode 16 mentioned above, and a reference numeral 2202 depicts the Si penetrating via, which is formed corresponding to the pad of the bias electrode 16, respectively.

Next, on a surface of the second layer 222 is provided a pad 2221 corresponding to the through Si via 2214 of the first layer 221, and also is formed a comparator circuit 2222, at an output terminal of which is provided the through Si via 2223. Also, on the surface of the second layer 222 is formed a resistor 2224, an end thereof being connected to one of inputs of the comparator circuit 2222 mentioned above, and the other end thereof being connected to a through Si via 2225 to be connected with a comparison reference voltage V_{Ref}. Also, at the positions corresponding to the through Si vias 2201 and 2202 of the first layer 221 mentioned above are formed the through Si vias 2201 and 2202, in the similar manner to the above.

Further, on a surface of the third layer 223 are formed a pad 2231 at the position corresponding to the through Si via 2223 of the second layer 222 mentioned above, and further a counter circuit 2232, an output thereof is connected to the through Si via 2233. Also, at the position corresponding to the through Si via 2225 formed on the second layer 222 mentioned above is formed the through Si via 2234. And on this third layer 223, there are also formed the through Si vias 2201 and 2202, at the positions corresponding to the through Si vias 2201 and 2202.

Finally, on the fourth layer (or substrate) 224 are provided the through Si vias 2241 and 2242, respectively, at the positions corresponding to the through Si via 2233 of the third layer and further the through Si via 2225, to which the comparison reference voltage V_{Ref} is connected, and on a lower end portion thereof (i.e., a reverse surface of the third layer 223) are formed pads, respectively. Also, in the similar manner to the above, on this fourth layer 224 are formed the through Si vias 2201 and 2202, and also are formed pads, respectively, as an output terminal, on the upper end portion thereof.

And, placing such semiconductor X-ray sensor portion 10, as was mentioned above, on a surface of the read-out portion 20, which is configured by combining the plural numbers of the read-out units 22 (8 pieces in the example shown in FIG. 1), flatly (i.e., on a plane), each being made up by piling up the layers, from the first layer to the forth layer, in one body, then outputs from the large number of pixel-like X-ray sensors (or cells), which are disposed on that surface aligning like an array, in other words, signals from the detecting electrodes 14, 14 . . . are treated with a predetermined process(es) thereon, respectively, within the read-out circuits inside the plural numbers (e.g., 8 pieces) of read-out units 22, and are taken out through the pads, i.e., the large number of terminals, which are provided on the lower surface thereof. Also, applying the bias voltage −V_{B} to the bias electrodes necessary for driving the semiconductor X-ray sensor portion 10 mentioned above, and/or grounding the earth electrode 16 can be conducted, in the similar manner, through the through Si vias 2201 and 2202, which are formed in part of the read-out unit 22.

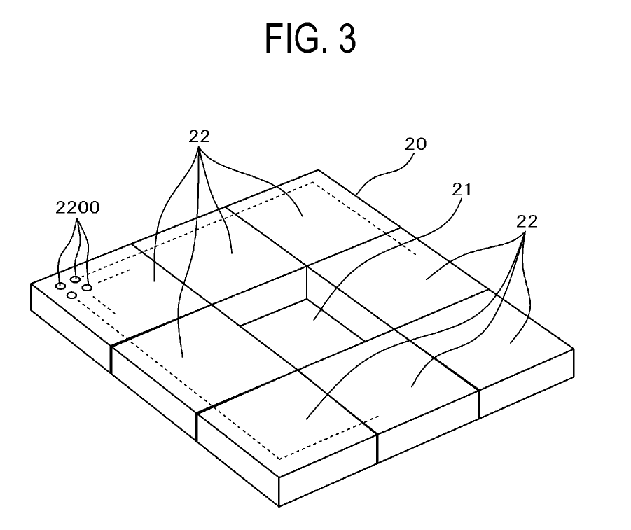

Further, an outlook of the read-out portion 20 is shown in FIG. 3 attached herewith, which is constructed assembling eight (8) pieces of such read-out units 22 as was mentioned above, in one body, under the condition of being viewed from the reverse surface thereof. As is apparent from this figure, on the reverse surface of the read-out portion 20, which is made up by assembling that eight (8) pieces of such read-out units 22 flatly (e.g., on a plane) in one body, there are provided the pads 2200 arranged or aligned thereon, by a number of summing up the numbers of the read-out circuits, which are formed within each read-out unit 22, thus, a number of the X-ray sensors (or cells) building up the semiconductor X-ray sensor portion 10 mentioned above (actually, in addition thereof, including a number of the pads formed on the lower ends of the through Si vias 2201, 2202 and 2242, necessary for applying the bias voltage supplying −V_{B} to the bias electrodes 13 and for grounding the earth electrode 16, and further for supplying the comparison reference voltage V_{Ref}).

And, the outputs, which are outputted from the read-out portion 20 mentioned above through the large number of pads 2200 (i.e., a signal from the detecting electrode 14 of each of the X-ray sensors (or cells) of the semiconductor X-ray sensor portion 10 mentioned above) are further led to the wiring portion 30 mentioned above, which is built up with the wire bonding pads, and are outputted through the terminal portion 32 provided on the side wall portion thereof, while being reduced in a number of the outputs therefrom, though not shown in the figure, but by means of a parallel/serial converter or a channel switch or a multiplexer, etc., for example, which is provided in an inside thereof.

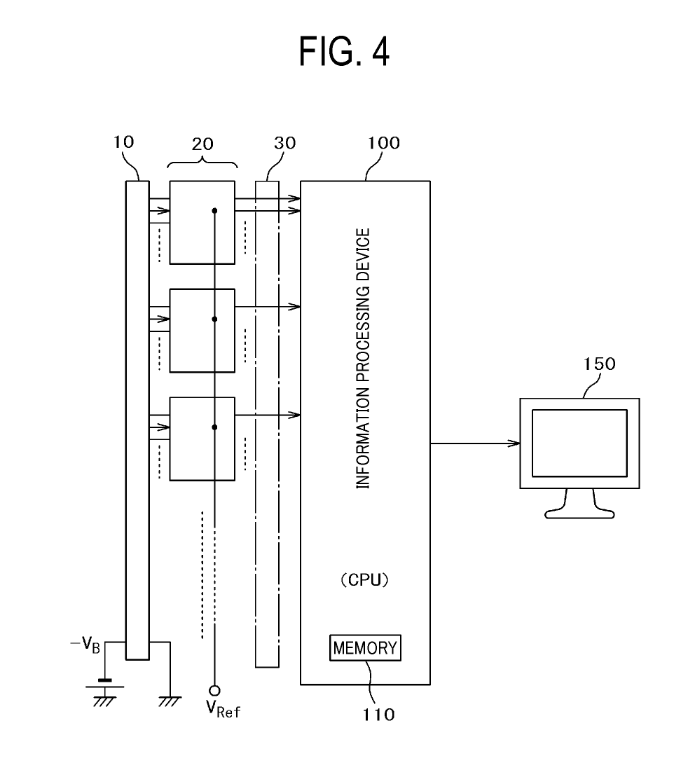

Following to the above, FIG. 4 attached herewith shows the circuitry configuration of an entire of the X-ray analyzing apparatus, in particular, when applying the semiconductor X-ray detector according to the present invention therein, including the semiconductor X-ray sensor portion 10, the read-out portion 20, and further the wiring portion 30 as was mentioned above. Namely, as is apparent from the figure, the signals detected from the large number of the X-ray sensors (or cells) building up the semiconductor X-ray sensor portion 10 (i.e., signals from the detecting electrodes 14) are led to the read-out portion 20, which is made up with the plural numbers (e.g., 8 pieces) of the read-out units 22 provided on the reverse surface thereof, and after being treated with the predetermined process(es) in processing circuits, which are formed in a large number thereof in an inside thereof through ASIC, they are inputted into an information processing device 100, being constructed with including a CPU therein, for example, wherein various analyzing processes are executed, upon basis of information of the diffracted X-rays obtained, and further a result thereof is displayed on a display portion (e.g., a display device) 150.

And, within the information processing device 100, in particular, when processing the detected signals from the large number of the X-ray sensors (or cells) building up the semiconductor X-ray sensor portion 10, it is possible to make a detect of an incident X-ray, correctly, at the large number of detecting positions on that XY plane, by memorizing the position (e.g., the coordinates) on an XY plane of each X-ray sensor (or cell), which can be determined upon combination of the eight (8) pieces of the read-out units 22, in advance, into a memory 110, etc., which is provided in an inside thereof.

Further, according to the semiconductor X-ray detector according to the present invention, in particular, within such read-out portion 20 as was mentioned above, the signals detected from the semiconductor X-ray sensor portion 10 are treated with the predetermined processes thereon, respectively. Thus, on the signal detected from the detecting electrode 14, i.e., the output terminal of each X-ray sensor (or cell), for example, an amplifying process, a wave shaping process, a comparing process and a counting process are executed, by means of the circuits, which are formed within the plural numbers (8 pieces) of the read-out units 22 building up the read-out portion 20 through the ASIC, and then it can be taken out as a signal for indicting the intensity of the incident X-ray, and therefore it may be preferable to apply that detector into the X-ray analyzing apparatus, in particular, for measuring characteristics of a sample with using the diffracted X-ray.

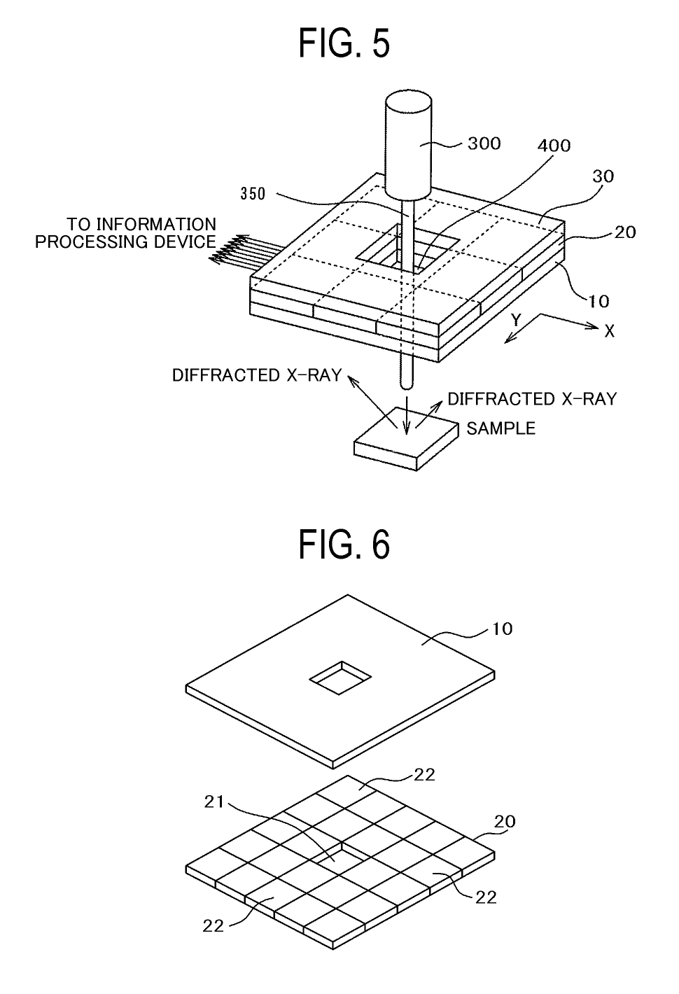

FIG. 5 attached herewith shows an example of detection of the diffracted X-ray, when building up the X-ray analyzing apparatus for detecting the X-ray diffracted from the sample, with applying such semiconductor X-ray detector as was mentioned above. Thus, an X-ray, being generated by a small-size X-ray tube 300 and passing through an incident optic system 350, such as, a collimator or the like, for example, is irradiated upon a sample, perpendicular thereto, passing through a penetrating hole 400 (being made up with the opening portions 11, 21 and 31), which is formed at a central portion of the X-ray detector, for example, being constructed by laminating the semiconductor X-ray sensor portion 10, the read-out portion 20 and the wiring portion 30 in one body. With doing this, detection is made on the intensity of the diffracted X-ray generated from that sample by means of the X-ray sensor portion 10, the read-out portion 20 and the wiring portion 30 building up the X-ray detector. As is apparent from this figure, the X-ray detector according to the present invention, can be made small in sizes thereof, easily, and also since it is preferable to be applied in a detector having an optical length relatively short, therefore it can be applied, in particular, into a portable X-ray diffractometer of hand-held type, etc.

Further, FIG. 6 attached herewith shows a variation of the semiconductor X-ray detector mentioned above. In this example a number of pieces of the read-out units 22 is increased, for building up the read-out portion 20 mentioned above, corresponding to the semiconductor X-ray sensor portion 10 being larger much more, for example, and herein is shown an example of combining 24 pieces of the units. However, an illustration will be omitted, herein, for simplification of the explanation thereof, in particular, regarding the wiring portion 30 thereof.

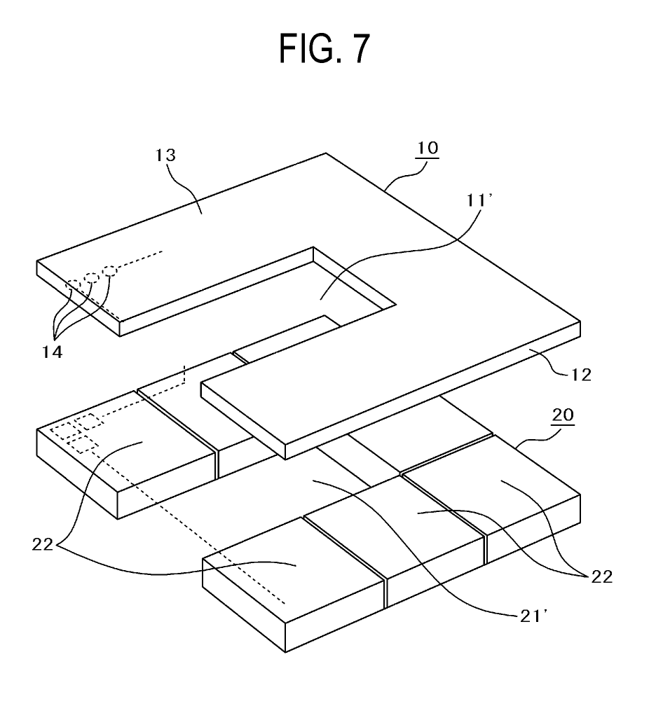

Also, FIG. 7 attached herewith further shows the configurations of the semiconductor X-ray sensor portion 10 and the read-out portion 20, as further other variation, each of which is formed into a U-shape, in the place of the O-shape mentioned above. However, with this example, it is apparent for the person skilled in the art that the X-ray generated by the X-ray tube 300 is irradiated upon the surface of the sample through cut-off portions 11′ and 21′ thereof, in the place of the opening portions 11 and 21 formed at the center.

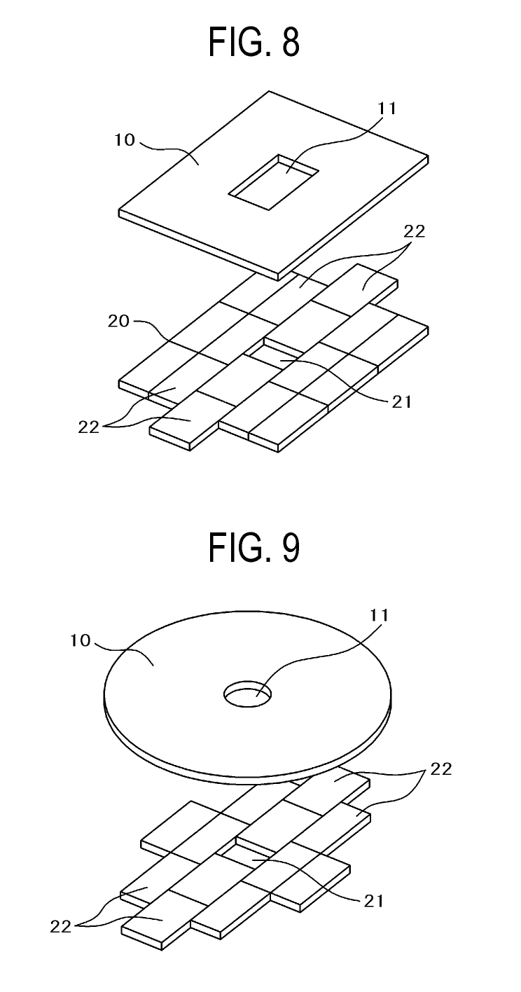

In addition to the above, FIG. 8 attached herewith shows an example of combining plural numbers (e.g., 16 pieces) of the read-out units 22, each having an oblong shape, in the place of the read-out unit being nearly quadrate in the shape thereof. However, in this example, the semiconductor X-ray sensor portion 10 and the read-out portion 20 are not coincident with, in particular, in the shape thereof. Further, FIG. 9 attached herewith shows an example of combining plural numbers (e.g., 12 pieces) of the rectangular read-out units 22, with respect to a disc-like semiconductor X-ray sensor portion 10, and also in this case the semiconductor X-ray sensor portion 10 and the read-out portion 20 are not coincident with, in the shape thereof. However, even in such case, as was mentioned above, it is possible to obtain the function of detecting the X-ray in the similar manner to that mentioned above, if inputting (or storing) information in advance, indicating that there is no corresponding X-ray sensor (or cell) into the memory 110, etc., for building up the information processing device 100 mentioned above. Further, in this case, it is preferable to arrange the plural numbers of read-out units fitting to the configuration of the semiconductor X-ray sensor portion mentioned above; in other words, in such manner that the number of the plural numbers of pixel-like X-ray sensors for building up the semiconductor X-ray sensor portion comes to be nearly equal to a total number of the processing circuit portions, which are built up within the read-out portion built up with the plural numbers of the read-out units.

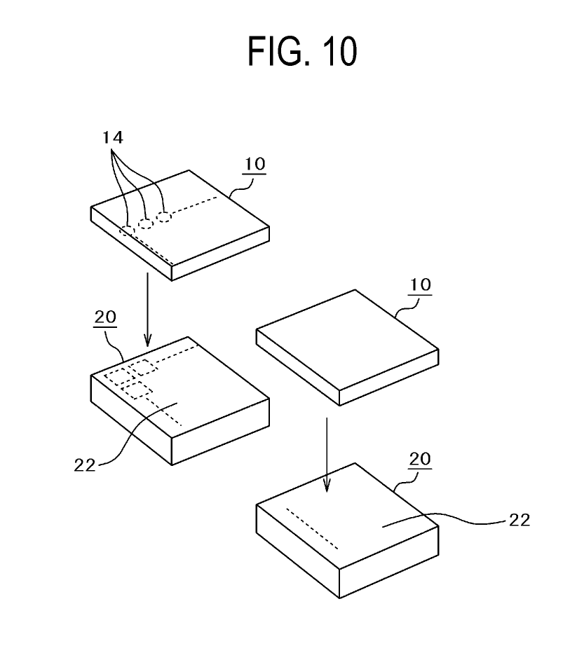

Or, alternately, in the place of the embodiment mentioned above, as is shown in FIG. 10 attached herewith, the semiconductor X-ray sensor portions 10 and also the read-out units 22 are prepared, each being shaped into the same configuration to each other (in the present example, a rectangle), in advance, and then those are piled up into one body. And, combining those, each being formed in one body as a unit, in plural numbers thereof, appropriately, it is possible to build up the X-ray detector having the opening portion (or, the penetrating hole) or the cut-off portion at the central portion thereof, in the similar manner to that mentioned above.

As is apparent from the explanation mentioned above, the X-ray detector, according to the present invention, has the semiconductor X-ray sensor portion 10, having the opening portion (or, the penetrating hole) at the central portion thereof and being formed into the shape enabling to detect the diffracted X-ray irradiating from the sample in a ring-like manner (in the present example, in the O-shape or the U-shape), in the periphery thereof, and further having the large number of X-ray sensors (or cells) in an inside thereof, while on the reverse surface thereof is laminated the read-out portion 20, thereby to be attached with in one body, being shaped into the configuration same or corresponding to that of the semiconductor X-ray sensor portion 10 mentioned above, by combining the read-out units 22, in the plural numbers thereof, being so-called the ASICs, each being formed into a rectangle and formed with the large number of processing circuits in an inside thereof through the 3-dimensional mounting. As a result thereof, it is possible to form those processing circuits in the large numbers thereof, corresponding to the large number of the X-ray sensors (or cells) of the semiconductor X-ray sensor portion 10 mentioned above, within that read-out portion 20, and the output terminals thereof are so constructed that they can be taken out on the reverse surface of the read-out portion 20, through the through Si vias.

And, with such the structures as was mentioned above, it is possible to buildup the read-out portion, easily, corresponding to the semiconductor X-ray sensor having the opening portion (or the penetrating hole) at the central portion thereof, by combining the read-out units 22, each being constructed with the ASIC, in plural numbers thereof, appropriately, fitting to the configuration of the semiconductor X-ray sensor portion 10 mentioned above. In that instance, by taking out the output terminals thereof from the reverse surface of the read-out portion 20, in particular, no restriction is imposed upon the number of pieces and/or the configuration when combining the plural numbers of the read-out units, and therefore it is possible to assemble them into a desired shape, freely. In particular, as a result of combining the plural numbers of the read-out units, the output terminals thereof can be taken out from the reverse surface thereof, easily, even if apart of the units is surrounded by other unit(s) on four (4) sides, on the periphery thereof. For that reason, it is possible to build up the plural numbers of the units into a desired configuration by combining them, and in particular, there can be provided the semiconductor X-ray detector having the opening portion formed at the central portion thereof, so that it can be constructed into the configuration suitable for detecting the diffracted X-ray at the short distance.

### EXPLANATION OF MARKS

10 . . . semiconductor X-ray sensor portion, 11 . . . opening portion (or hole), 12 . . . X-ray detecting portion, 13 . . . bias electrode, 14 . . . detecting electrode, 20 . . . read-out portion, 21 . . . opening portion (or hole), 22 . . . read-out unit, 2211 . . . pad, 2212 . . . amplifier, 2213 . . . wave shaping circuit, 2222 . . . comparator circuit, 2232 . . . counter circuit, 2214, 2223, 2225, 2233, 2234, 2241 and 2242 . . . through Si via, 2200 . . . pad, 30 . . . wiring portion.

What is claimed is:

1. A semiconductor X-ray detector, comprising:
a semiconductor X-ray sensor portion, which has a plate-like outer shape including at least an opening portion near to a central portion thereof, and is formed with plural numbers of pixel-like X-ray sensors between a surface and a reverse surface thereof; and
a read-out portion, which is disposed on the reverse surface of said semiconductor X-ray sensor portion, and executes a predetermined process on each of signals outputted from the plural numbers of said X-ray sensors building up said semiconductor X-ray sensor portion, thereby outputting detected signals therefrom, wherein
said read-out portion is built up by assembling read-out units in plural numbers thereof, flatly in one body, each being formed into a plate-like rectangular shape, with forming plural numbers of input portions on a surface thereof, as well as, having plural numbers of processing circuit portions and plural numbers of through hole vias in an inside thereof, and further having plural numbers of output terminals on a reverse surface thereof, and further said semiconductor X-ray sensor portion and said read-out portion are laminated to be formed into one body.

2. The semiconductor X-ray detector, as described in the claim 1, wherein said semiconductor X-ray sensor portion has an opening portion at a central portion thereof, and an outer shape thereof is made O-shaped or U-shaped, or circular.

3. The semiconductor X-ray detector, as described in the claim 1, wherein a number of the plural numbers of pixel-like X-ray sensors for building up said semiconductor X-ray sensor portion is nearly equal to a total number of the processing circuit portions, which are formed in an inside of said read-out portion, being built up with plural numbers of said read-out units.

4. The semiconductor X-ray detector, as described in the claim 1, wherein each of said plural numbers of read-out units for building up said read-out portion is constructed with ASIC, in an inside of which said plural numbers of processing circuit portions are formed in a 3-dimensional manner.

5. The semiconductor X-ray detector, as described in the claim 1, wherein the detected signals outputted from said read-out portion are intensity signals of incident X-rays.

6. A semiconductor X-ray detector, comprising:
a semiconductor X-ray sensor portion, which has a plate-like outer shape including at least an opening portion near to a central portion thereof, and is formed with plural numbers of pixel-like X-ray sensors between a surface and a reverse surface thereof; and
a read-out portion, which is disposed on the reverse surface of said semiconductor X-ray sensor portion, and executes a predetermined process on each of signals outputted from the plural numbers of said X-ray sensors building up said semiconductor X-ray sensor portion, thereby outputting detected signals therefrom, wherein
said read-out portion is built up with plural numbers read-out units, each being formed into a plate-like rectangular shape, with forming plural numbers of input portions on a surface thereof, as well as, having plural numbers of processing circuit portions and plural numbers of through hole vias in an inside thereof, and further having plural numbers of output terminals on a reverse surface thereof,
said semiconductor X-ray sensor portion is laminated on each of surfaces of the read-out units for building up said read-out portion, to be formed in one body, and
said read-out portion and said semiconductor X-ray sensor portion are assembled flatly in one body, by plural numbers of units, each including said read-out unit and a part of said semiconductor X-ray sensor portion, which is laminated on a surface thereof in one body.
